(19) United States
(12) Patent Application Publication
(10) Pub. No.: US 2003/0041959 A1
(43) Pub. Date: Mar. 6, 2003

(54) Pattern for glass cutting and method for using the pattern

(76) Inventor: Moosey Cynthia M., Sturbridge, MA (US)

Correspondence Address: BLODGETT BLODGETT, 43 HIGHLAND STREET, WORCESTER, MA, 016092797

(21) Appl. No.: 10/217,942

(22) Filed: Aug. 13, 2002

Related U.S. Application Data
(60) Provisional application No. 60/312,172, filed on Aug. 14, 2001.

(51) Int. Cl. B32B 31/00

(52) U.S. Cl. 156/247; 156/248; 156/250; 156/249

(57) ABSTRACT

A pattern for cut glass and the like. The pattern is a substrate having a line at the peripheral edge of the substrate and a releasable adhesive on the bottom surface of the substrate. The pattern is formed by placing an adhesively backed substrate sheet on a sheet of release paper, drawing a closed line on the substrate sheet and cutting along the outside of the line. The pattern is used by removing it from the release paper, adhering the pattern on a sheet of glass, cutting the glass along the outside of the pattern, polishing the cut edge of the glass piece, and removing the pattern from the glass piece.

### CROSS-REFERENCE TO RELATED APPLICATIONS

This application claims the benefit under 35 U.S.C. §119(e) of prior U.S. Provisional Application No. 60/312,172 filed Aug. 14, 2001; which is hereby incorporated by reference.

### STATEMENT REGARDING FEDERALLY SPONSORED RESEARCH OR DEVELOPMENT

This invention has been created without the sponsorship or funding of any federally sponsored research or development program.

### BACKGROUND OF THE INVENTION

The present invention is directed generally to the field of decorative cut glass and, specifically, to patterns for cutting individual pieces of decorative glass or similar material and the method of using such patterns.

The art of forming mosaic designs of cut glass is well known. Stained glass windows for churches and globes for lamps are two of many familiar areas in which pieces of cut glass are used to form decorative mosaic designs.

Traditionally, individual glass pieces are cut from glass stock with the assistance of printed patterns. A pattern having the shape of the glass piece to be cut is printed on either paper or an opaque plastic such as mylar. The pattern is cut out by the user and placed on a piece of glass stock. The user then traces the pattern on the glass stock with a felt marker. The user then cuts around the traced line to remove the rough glass piece from the glass stock. The rough glass piece is ground to the inside of the traced line.

The problem with the above procedure is that when the line has been ground off, there is no way to know if the user has gone too far and by how much. The step of tracing the pattern is not a precise act and represents a first error factor. The loss of the traced line during grinding represents a second error factor. These and other difficulties experienced with the prior art coating systems have been obviated by the present invention.

It is, therefore, a principal object of the invention to provide an improved pattern for cutting individual pieces from glass or similar hard material.

A further object of the present invention is the provision of a pattern for cutting individual pieces from glass or similar hard material in which the pattern is adhered to and remains with the individual piece throughout the cutting and finishing steps for the individual piece.

Another object of the present invention is the provision of an improved pattern for cutting individual pieces from glass or the like and an improved method for cutting and finishing the individual pieces with the use of the pattern.

### BRIEF SUMMARY OF THE INVENTION

The invention comprises a similar transparent pattern for cutting an individual piece from a slab or sheet of glass stock or other material. The back surface of the pattern contains a releasable adhesive. The pattern is carried on a sheet of release paper along with other patterns. The pattern is formed by printing a closed line on a sheet of substrate such as clear substrate. The vinyl substrate is removably attached by means of an adhesive coating, to a sheet of release paper. Other patterns are printed on the vinyl sheet as well. A cut is made along the outside of the pattern line. The pattern is removed from the release paper and applied to a sheet of glass stock. A cut is made in the glass around the outside of the line which defines the pattern and the glass piece, with the pattern adhered thereto, is removed from the sheet of glass. The glass piece is “finished” by grinding the peripheral edge of the piece until it is smooth. The pattern, including the line remains on the glass piece while it is being “finished”. After the glass piece has been finished and is ready to be used, for example, in a mosaic pattern, the pattern is removed and discarded.

### BRIEF DESCRIPTION OF THE DRAWINGS

The character of the invention, however, may be best understood by reference to one of its structural forms, as illustrated by the accompanying drawings, in which:

FIG. 1 is a top plan view of a substrate containing a plurality of patterns embodying the principals of the present invention, shown mounted on a sheet of release paper;

FIG. 2 is a view similar to FIG. 1 showing one of the patterns partially removed from the release paper;

FIG. 3 is a top plan view of the pattern which has been removed from the release paper and applied to a sheet of glass stock;

FIG. 4 is a view of the glass stock of FIG. 3 after a piece of glass, having the shape of the pattern has been removed from the glass stock;

FIG. 5 is a top plan view of the piece of glass, with the pattern applied thereto, which has been removed from the sheet of glass of FIGS. 3 and 4; and

FIG. 6 is a view similar to FIG. 5 showing the pattern partially removed from the piece of glass.

### DETAILED DESCRIPTION OF THE INVENTION

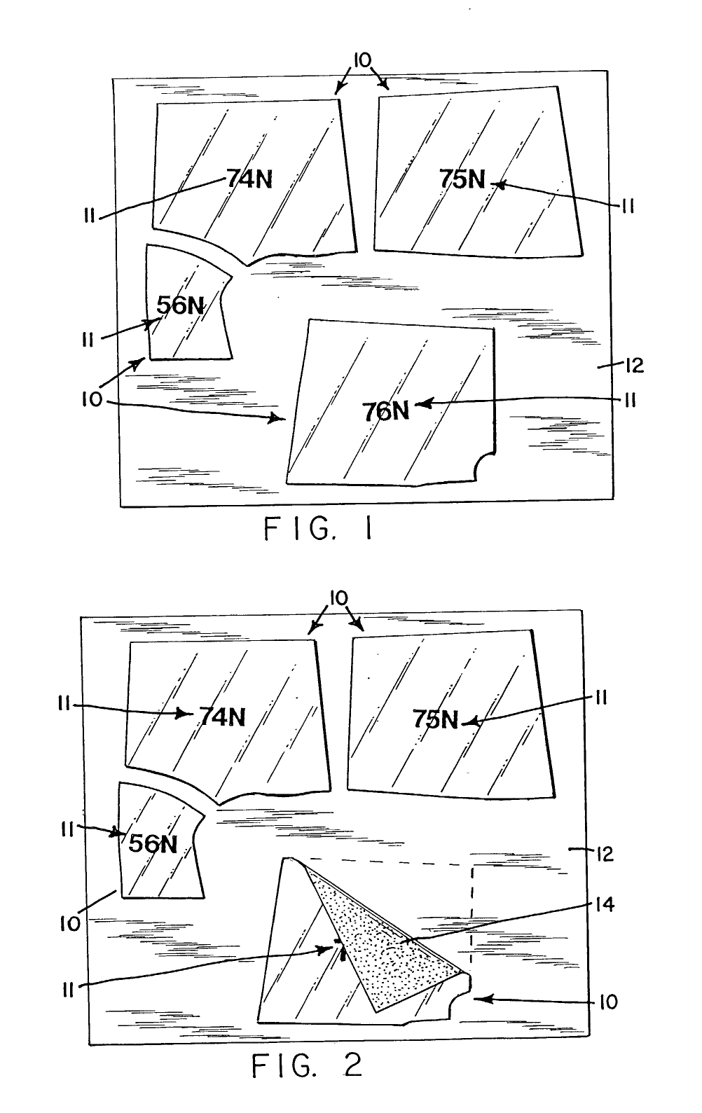

Referring first to FIGS. 1 and 2, there is shown a plurality of patterns, generally indicated by the reference numeral 10, embodying the principals of the present invention applied to a sheet of release paper 12. Each pattern 10 has a different shape and has printed on its top surface an indicia, generally indicated by the reference numeral 11. The indicia 11 serves as an identifier for the particular size and shape of the pattern for subsequent application into a predetermined mosaic design. In the example shown in FIG. 1, the indicia 11 for the patterns shown therein are 56N, 74N, 75N and 76N. The bottom of each pattern 10 has a layer of hi-tech waterproof releasable adhesive 14 which maintains the pattern on the release paper and which enables the pattern to be removed from the release paper for subsequent use.

The patterns are formed by printing the pattern on a sheet of substrate such as clear vinyl substrate that is releasably attached to a sheet of release paper by means of the adhesive 14. The patterns are printed with the use of a Gerber Edge machine. The shapes and sizes of the patterns are determined by digital information utilized by the Gerber Edge machine. The vinyl substrate is then cut along the outside of the printed lines of each pattern with the use of a plotter using the same digital information that was used to print the lines for the patterns. The portions of the substrate between the patterns is removed, leaving the individual pattern pieces on the release paper. An example of a vinyl release paper laminate sheet for use for the present invention is sold by 3M Corporation under the trademark and is further identified as a 220 film that has been formulated by 3M especially for Gerber Scientific Products.

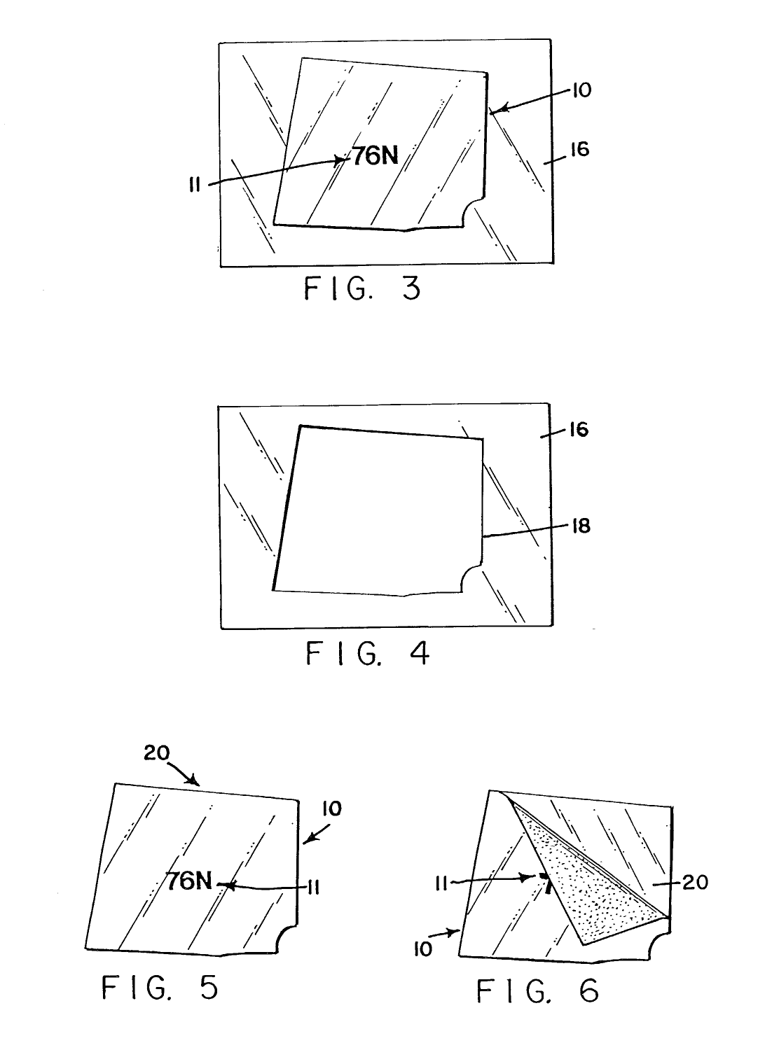

Each pattern 10 is utilized by removing it from the release paper 12 and applying it to a sheet of glass stock. In the example shown in FIG. 2, the pattern 10 containing the indicia 76N is removed from the release paper 12 and applied to a sheet of glass or similar material 16 as shown in FIG. 3. Since the pattern is clear or transparent, the user can selectively position the pattern to take advantage of a particular grain or texture in the glass that may be preferred by the user. Before the piece of glass is cut from the sheet of glass stock 16, the user can see exactly what the cut piece of glass will look like with respect to grain or texture. After the pattern 76N is in position on the sheet of glass 16, a cut is made in the glass along the outside of the line that defines the pattern. The piece of cut glass with the pattern adhere to is then removed from the sheet of glass 16, leaving a hole 18 in the sheet of glass. The piece of cut glass, with the pattern 76N adhered thereto, is generally indicated by the reference numeral 20 in FIG. 5. The piece of glass 20 is finished by grinding the peripheral edge of the glass so that the edge is smooth. The pattern of the glass piece 20 extends to the outside of the line which defines the pattern 76N so that the line remains on the glass piece throughout the finishing process. Since the line defining the pattern 76N is never removed, the user is always aware of the outer dimensions of the glass piece throughout the finishing process. Indicia 11 enables the finished glass piece 20 to be properly positioned in the predetermined mosaic design of which the glass piece 20 is a part. At this point, the pattern 76N can be removed from the glass piece 20, as shown in FIG. 6.

1. A pattern for forming a planar piece of a desired shape from glass and other similar materials, said pattern comprising:
(a) a planar substrate having a top surface, a bottom surface, and an outer peripheral edge defining said desired shape, said top surface having a first visual characteristic;
(b) a line at said peripheral edge having a second visual characteristic that is visually different from said first visual characteristic; and
(c) a releasable adhesive on said bottom surface.

2. The pattern as described in claim 1, wherein said second visual characteristic is substantially darker than said first visual characteristic.

3. The pattern as described in claim 2, wherein said substrate is a transparent material and said line is opaque.

4. The pattern as described in claim 1, wherein said substrate is plastic.

5. The pattern as described in claim 4, wherein said plastic is clear vinyl.

6. The pattern as described in claim 1, further comprising a sheet of release material releasably attached to the bottom surface of said substrate for protecting said adhesive from contacting any material other than said sheet of release material.

7. The pattern as recited in claim 1, wherein said substrate further comprises visual identifying indicia on the top surface of said substrate.

8. The pattern as recited in claim 7, wherein said visual identifying indicia has a visual characteristic that is visually different from said first visual characteristic.

9. A method of forming a planar piece having a desired shape from a sheet of rigid material, said method comprising:
(a) applying a planar pattern having said desired shape on said sheet of rigid material, said pattern having a top surface, a bottom surface, a peripheral edge, a line at said peripheral edge that is visually distinct from said top surface and a releasable adhesive on said bottom surface for enabling said pattern to be releasably attached to said sheet of rigid material;
(b) cutting said sheet of rigid material along the outside of said line to form said planar piece; and
(c) removing said pattern from said piece.

10. The method as recited in claim 9, wherein said planar material is glass and said piece has a peripheral edge and said method comprises grinding the cut peripheral edge of said piece prior to removal of said pattern from said piece so that the peripheral edge of said piece is smooth.

11. A method of making a pattern for forming a planar piece of a desired size and shape, said method comprising:
(a) forming a closed line on the top surface of a planar substrate having said closed line differing visually from said top surface for defining said desired size and shape; and
(b) cutting said planar substrate along with outside of said closed line.

12. The method as recited in claim 11, comprising the additional step of applying identifying indicia on said top surface within said closed line.

13. A method of making a pattern for forming a planar piece of a desired two-dimensional shape, said method comprising:
(a) applying a releasable contact adhesive on the bottom surface of a sheet of substrate;
(b) releasably attaching a sheet of releasable supporting material to the bottom surface of said sheet of substrate;
(c) forming a closed line on the top surface of said sheet of substrate, said closed line differing visually from said top surface for defining said two dimensional shape; and
(d) cutting said sheet of substrate along the outside of said closed line.

14. The method as recited in claim 13, comprising:
(a) forming additional closed lines on the top surface of said substrate for defining additional desired two-dimensional pattern shapes; and
(b) cutting along the outside of each of said additional closed lines to form additional two-dimensional patterns having additional desired sizes and shapes.

15. The method as recited in claim 14, comprising the additional step of applying identifying indicia on each of said two-dimensional patterns.

16. The method as recited in claim 14, comprising the additional step of removing the portions of said substrate outside of said closed lines from said releasable, supporting material.

17. The method as recited in claim 13, wherein the forming of said closed line and the cutting of said sheet are accomplished with the use of a digitally controlled plotter.
